(19) United States
(12) Patent Application Publication
(10) Pub. No.: US 2026/0268142 A1
(43) Pub. Date: Sep. 10, 2026

(54) AUTOMATIC PRUNING MASK FOR LARGE LANGUAGE MODELS WITH BALANCED WEIGHT AND ACTIVATION

(71) Applicant: Xilinx, Inc., San Jose, CA (US)

(72) Inventors: Lian Liu, Beijing (CN); XianDong Zhao, Beijing (CN); Dong Li, Beijing (CN); Emad Barsoum, Sammamish, WA (US); Lu Tian, Beijing (CN)

(21) Appl. No.: 19/072,463

(22) Filed: Mar. 6, 2025

(51) Int. Cl. G06N 3/082; G06N 3/0455

(52) U.S. Cl. CPC G06N 3/082; G06N 3/0455

(57) ABSTRACT

An apparatus and method for efficiently performing efficient data storage and data transfer of machine learning data. In various implementations, one of the multiple processing circuits of the computing system retrieves matrix of machine learning (ML) model weights (or weights). The processing circuit performs magnitude normalization across one or more channel dimensions of the matrix of weights. The processing circuit performs activation magnitude normalization across one of the channel dimensions of the input activation values. The processing circuit generates a pruning mask for the matrix of weights based on a combination of the weight magnitude normalization and the activation magnitude normalization.

### BACKGROUND

### Description of the Relevant Art

The parallelization of tasks is used to increase the throughput of computing systems. To this end, compilers extract parallelized tasks from applications to execute in parallel on the computing system hardware. Parallel data processing circuits execute multiple threads simultaneously in order to take advantage of the identified instruction-level parallelism. The performance of computing systems increases with the scheduling of parallel data tasks on parallel data processing circuits. One or more of these parallel data processing circuits can support a machine learning (ML) model. The ML model uses machine learning techniques that rely on one of a variety of types of neural network structures. The ML model uses one or more layers of nodes to generate an output value representing a prediction when given a set of input data values.

With the addition of one or more parallel data processing circuits, the computing system hardware supports the data computing requirements of executing the instructions of the ML model. However, the computing system hardware also needs to support the data storage requirements and the memory bandwidth requirements of the ML model. The parameters of the ML model include the input data values, the weight values, the bias values, and the activation values such as activation tensors. In some designs, a representative number of the relatively high number of these parameters used by the ML model can range from tens of billions of parameters to hundreds of billions of parameters. In some designs, a representative amount of data storage of these parameters in one memory can range from hundreds of gigabytes to a few terabytes with data transfer rates reaching hundreds of gigabytes per second.

The computing system typically includes second memory such as an off-chip hard disk drive or solid-state drive. Examples of the user’s computing device that includes the computing system are a desktop computer, a laptop computer, a tablet computer, a smartphone, a smartwatch and so forth. Even if the secondary memory can support the above data storage requirement, the other levels of the memory hierarchy located closer to the one or more parallel processing circuits typically can’t provide the data storage requirement and data transfer rates for supporting execution of the ML model. Therefore, the performance suffers or the computing device is unable to execute applications relying on the ML model.

In view of the above, methods and apparatuses for efficient support of machine learning model data storage requirements and data transfer rates requirements are desired.

### BRIEF DESCRIPTION OF THE DRAWINGS

FIG. 1 is a generalized diagram of weights pruning in a computing system that performs efficient data storage and data transfer of machine learning data.

FIG. 2 is a generalized diagram of a machine learning model that performs efficient data storage and data transfer of machine learning data.

FIG. 3 is a generalized diagram of a machine learning initial attention stage that performs efficient data storage and data transfer of machine learning data.

FIG. 4 is a generalized diagram of an attention layer of a machine learning model.

FIG. 5 is a generalized diagram of encoder and decoder block components of a machine learning model.

FIG. 6 is a generalized diagram of processing stages of a transformer of a machine learning model.

FIG. 7 is a generalized diagram of a computational graph of a machine learning model.

FIG. 8 is a generalized diagram of a method for performing efficient data storage and data transfer of machine learning data.

FIG. 9 is a generalized diagram of a computing system that performs efficient data storage and data transfer of machine learning data.

FIG. 10 is a generalized diagram of an apparatus that performs efficient data storage and data transfer of machine learning data.

FIG. 11 is a generalized diagram of a method for performing efficient data storage and data transfer of machine learning data.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for performing efficient data storage and data transfer of machine learning data are disclosed. In various implementations, the host processing circuit of the computing system executes a machine learning (ML) parallel data application. In some implementations, the ML model is one of a variety of types of a large language model (LLM). In various implementations, the application is written by a developer in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Matplotlib, Pandas and so on. A predefined module can be called similar to a function call. The imported ML libraries are used to create a computational graph that provides the computational order of the ML nodes, layers and stages of the ML model. The host processing circuit uses a library that relies on a user mode driver (UMD) to translate function calls in the ML application to commands particular to a piece of hardware such as an accelerator circuit with a parallel data microarchitecture.

One of the multiple processing circuits of the computing system retrieves a matrix of machine learning (ML) model weights (or weights) corresponding to a particular ML layer. One or more levels of the memory hierarchy located closer to the processing circuit typically can’t provide the data storage requirement and data transfer rates for supporting execution of the ML model. The number of weights used to support the ML model can range from tens of billions to hundreds of billions. To reduce the number of weights, the processing circuit prunes (removes) a subset of the weights while maintaining accuracy of the ML model above a threshold. By “pruning” (removing) a selected weight, the processing circuit replaces the selected weight with a value of zero. The processing circuit generates a pruning mask that is used to select weights of the weights matrix to prune (remove).

When generating the pruning mask to prune the weights, in the proposed solution, the processing circuit generates a pruning metrics matrix to select which weights of the weights matrix at the particular ML layer to prune. When generating the pruning metrics matrix, the processing circuit accounts for both the weight magnitude distribution and the activation value magnitude distribution across the rows and columns (channels) of the matrix of weights at the particular ML layer and the matrix of activation values at the particular ML layer. The matrix elements (weights) of the weights matrix that have values much larger or much smaller than values of other matrix elements, such as having a difference in values greater than a threshold, are referred to as “outliers.” To reduce the effects of outliers in the weights matrix, the processing circuit generates matrix elements for the pruning metrics matrix by performing magnitude normalization of the weights matrix. Typical computing systems do not account for at least the weight magnitude distribution across the rows and columns (channels) of the matrix of weights. Typically, computing systems prune weights by using the absolute values of the matrix elements (individual weights) in the weights matrix, which does not account for the distribution of the weights across the rows and columns (channels) of the weights matrix. Therefore, typical computing systems do not accurately select weights to prune that have less influence on an output value of the particular ML layer, but instead inadvertently prune weights that have more influence on the output value of the particular ML layer. The accuracy of the ML model of these typical computing systems reduces as a result of the typical pruning steps.

To account for the weight magnitude distribution, the processing circuit calculates the weight magnitude normalization of the weights matrix at the particular ML layer. In an implementation, the processing circuit generates a first norm vector as the L2 norm values across the columns (input channel) of the weights matrix at the particular ML layer. The processing circuit generates a second norm vector as the L2 norm values across the rows (output channel) of the weights matrix at the particular ML layer. The processing circuit generates matrix elements of the pruning metrics matrix based on the values of the weights in the weights matrix, the first norm vector and the second norm vector. By doing so, the processing circuit performs magnitude normalization across one or more channel dimensions (e.g., rows and columns) of the weights matrix. Typical computing systems do not utilize the first norm vector and the second norm vector values of the weights matrix at the particular ML layer, and accordingly, generate a different pruning mask that provides lower accuracy of the ML model.

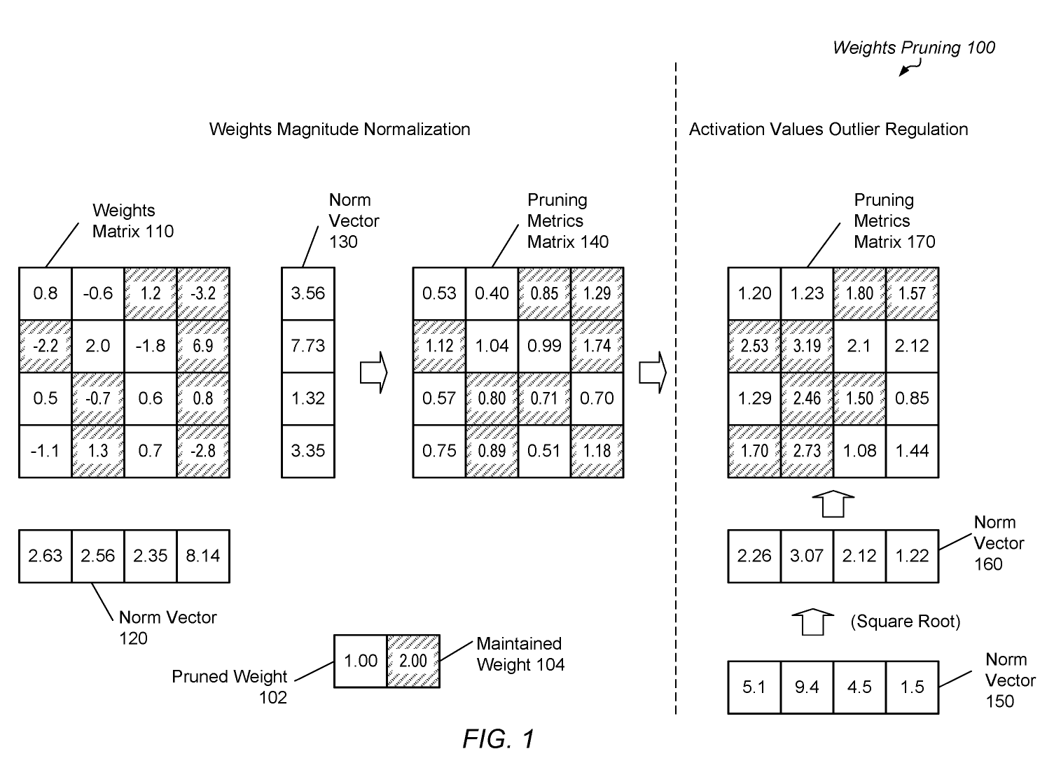

Additionally, the processing circuit performs activation magnitude normalization of input activation values across one of the channel dimensions (e.g., row or column) of an activation matrix. In an implementation, the processing circuit generates a third norm vector as the L2 norm values across either the row or the column of the activation matrix at the particular ML layer. The processing circuit generates matrix elements of the pruning metrics matrix based additionally on the input activation values in the activation matrix and the third norm vector. By doing so, the processing circuit reduces the effects of outliers in the activation matrix and increases accuracy of the ML model despite using pruning of weights. Reducing the effects of outliers in the weights matrix can be referred to as “magnitude normalization.” Reducing the effects of outliers in the activation matrix can be referred to as “outlier regularization.” The processing circuit generates the pruning metrics matrix to select which weights of the weights matrix at the particular ML layer to prune based on a combination of the weight magnitude normalization (magnitude normalization) and the activation magnitude normalization (outlier regularization). Further details of these techniques for performing efficient data storage and data transfer of machine learning data are provided in the following description of FIGS. 1-11.

Turning now to FIG. 1, a generalized diagram is shown of weights pruning 100 that performs efficient data storage and data transfer of machine learning model data. As shown, the computing system includes at least weights matrix 110. Here, shaded boxes 104 indicate weights that are maintained, whereas boxes 102 with no shading indicate weights that are pruned. The unshaded (or clear) boxes of weights matrix 110 indicate weights that are pruned when an absolute value of the weight magnitudes is used for pruning. Pruned weights are typically replaced with a value of zero. In various implementations, a processing circuit (not shown) of the computing system utilizes N:M sparsity when pruning weights where each of N and M is a positive, non-zero integer and M is greater than N. In an implementation, the processing circuit uses 2:4 sparsity where 2 weights are removed from each group of 4 non-overlapping weights. In an implementation, the group of M non-overlapping weights is an entire row (vector) of the weights matrix 110. The pruning technique that relies solely on the absolute value of the weight magnitudes is referred to as “magnitude pruning.”

In various implementations, the processing circuit generates the norm vector 120 as the L2 norm values across the columns of weights matrix 110. The columns of weights matrix 110 represent one of the multiple dimensions of the weight matrices. Examples of the dimensions are input channel, output channel, number of batches, and so on. The L2 norm of a vector, such as a row or a column of weights matrix 110, is equal to the square root of the sum of the squares of the vector elements. For the left-most norm value of 2.63 of norm vector 120, the processing circuit calculates [(0.8)^2 + (-2.2)^2 + (0.5)^2 + (-1.1)^2]^(1/2) = 2.63. The processing circuit performs the same steps for the other three columns (vectors) of weights matrix 110. For the top norm value of 3.56 of norm vector 130, the processing circuit calculates [(0.8)^2 + (-0.6)^2 + (1.2)^2 + (-3.2)^2]^(1/2) = 3.56. The processing circuit performs the same steps for the other three rows (vectors) of weights matrix 110.

To generate the pruning metrics matrix 140, the processing circuit generates two values for each of the matrix elements of weights matrix 110 and sums the two values. For the top and left-most pruning metric of 0.53 of pruning metrics matrix 140, the processing circuit calculates [(1 / 2.63) x 0.8] + [(1 / 3.56) x 0.8] = 0.529 = 0.53. For the top and second left-most pruning metric of 0.40 of pruning metrics matrix 140, the processing circuit calculates [(1 / 2.56) x 0.6] + [(1 / 3.56) x 0.6] = 0.403 = 0.40. For the second row from the top and left-most pruning metric of 1.12 of pruning metrics matrix 140, the processing circuit calculates [(1 / 2.63) x 2.2] + [(1 / 7.73) x 2/2] = 1.121 = 1.12.

By generating the pruning metrics matrix 140, the processing circuit performs weights magnitude normalization, which balances the weight magnitude distribution across two dimensions such as the input channel dimension and the output channel dimension. Accordingly, the processing circuit provides input channel normalization and output channel normalization. By doing so, the processing circuit does not exclusively focus on outliers in activation values, but also accounts for magnitudes of weights and the dynamic range and variation over time (and ML layers). As shown, the second row (vector) from the bottom of the matrix has different weight positions being pruned than what is shown for weights matrix 110 when simply magnitude pruning is used.

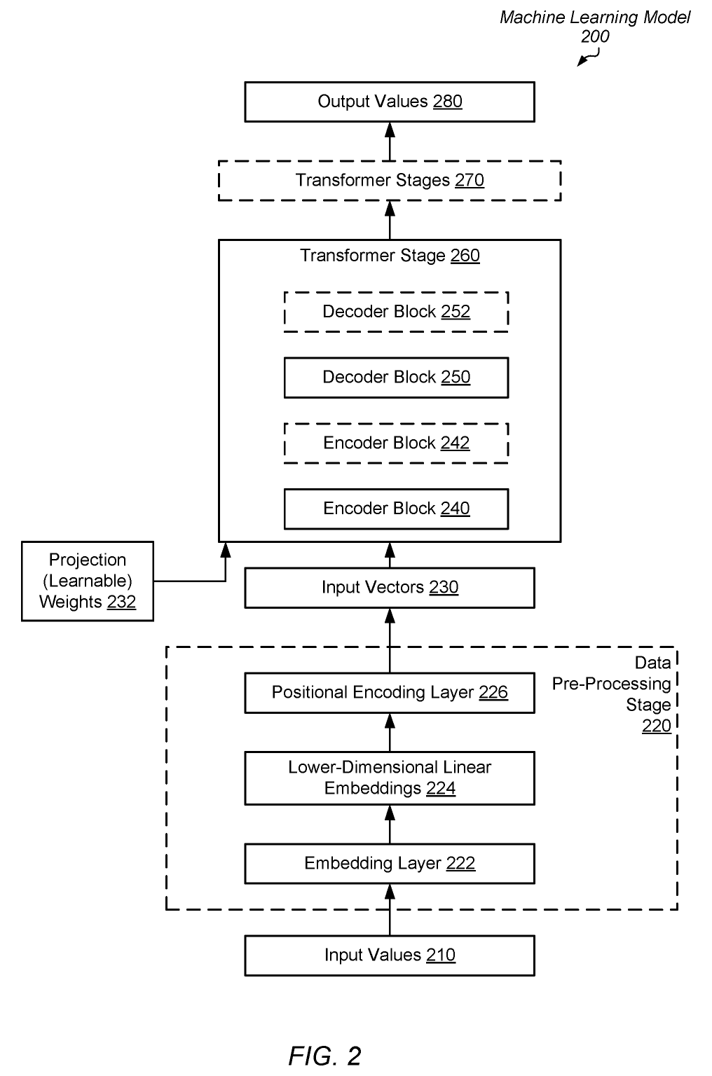

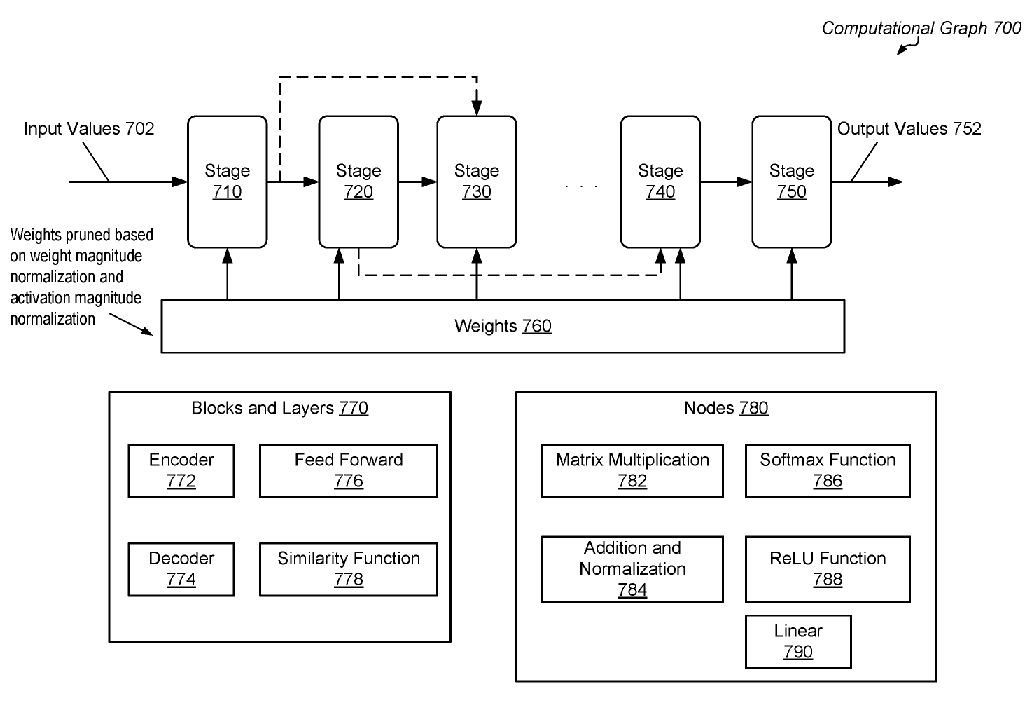

In various implementations, the processing circuit generates the norm vector 150 as the L2 norm values across the columns of a matrix of activation values (not shown). In some implementations, the activation values are activation values of a calibration dataset. In an implementation, 128 randomly selected input values are sent to an ML model and the resulting activation values are recorded. In some implementations, these values are used as the activation values for norm vector 150 at a particular ML layer or ML stage of a computational graph such as computational graph 700 (of FIG. 7). In other implementations, an average or other statistical analysis is performed to generate the activation values of particular ML layers or ML stages such as ML layers and ML stage shown in FIGS. 2 and 5-6.

In some implementations, the processing circuit utilizes a power factor, such as a power factor of ½, to generate the norm vector 160. Therefore, the processing circuit performs a square root of each of the norm values of norm vector 150 to generate the norm vector 160. Afterward, the processing circuit multiplies each of the pruning metric elements of pruning metrics matrix 140 by a norm value of a corresponding column (vector) of pruning metrics matrix 140. For the top and left-most pruning metric of 1.20 of pruning metrics matrix 170, the processing circuit calculates [0.53 x 2.26] = 1.20. For the top and second left-most pruning metric of 1.23 of pruning metrics matrix 170, the processing circuit calculates [0.40 x 3.07] = 1.23.

The shaded boxes 104 and unshaded (clear) boxes 102 of pruning metrics matrix 170 indicates the changes in selections of which weights to prune when compared to weights matrix 110 (magnitude pruning alone) and pruning metrics matrix 140 (weights magnitude normalization alone). The steps performed to generate pruning metrics matrix 170 consider both weight magnitude distribution and activation value magnitude distribution. Using weights magnitude normalization and activation values outlier regulation to generate pruning metrics matrix 170 accounts for the influence of the imbalanced distribution of weight magnitudes and the disproportionate influence of outliers. Combining these approaches provides an automatic pruning mask selection method, which systematically balances weight and activation distributions (BaWa). A further description of the environment that uses the weights, activation values (intermediate data) and the processing circuit of the computing system is provided in the description of FIGS. 2-11.

Referring to FIG. 2, a generalized diagram is shown of a machine learning model 200 that performs efficient data storage and data transfer of machine learning data. As shown, machine learning model 200 includes data pre-processing stage 220 and transformer stage (or model or layer) 260. In some implementations, machine learning model 200 includes one or more additional transformer stages such as at least transformer stage 270, which is shown in a dashed box since it is optional and can include more than one transformer stage. Data pre-processing stage 220 receives input values 210 and generates input vectors 230, which are sent to transformer stage 260. Transformer stage 260 (and any additional transformer stages 270) uses input vectors 230 to generate output values 280.

By using transformer stages (or models or layers) 260 (and any additional transformer stages 270), machine learning model 200 uses a neural network structure to generate output values 280 from input values 210 based on at least tracking relationships and relevance between elements of an input sequence (input values 210) and tracking long term dependencies or relationships with prior input values 210. Transformer stage (or model or layer) 260 (and any additional transformer stages 270) utilizes attention and self-attention mathematical techniques to track dependencies or relationships among elements of the input values 210 and previous input values. In various implementations, machine learning model 200 is a large language model (LLM), which includes multiple transformer stages relying on self-attention mathematical techniques for processing natural language processing (NLP) applications.

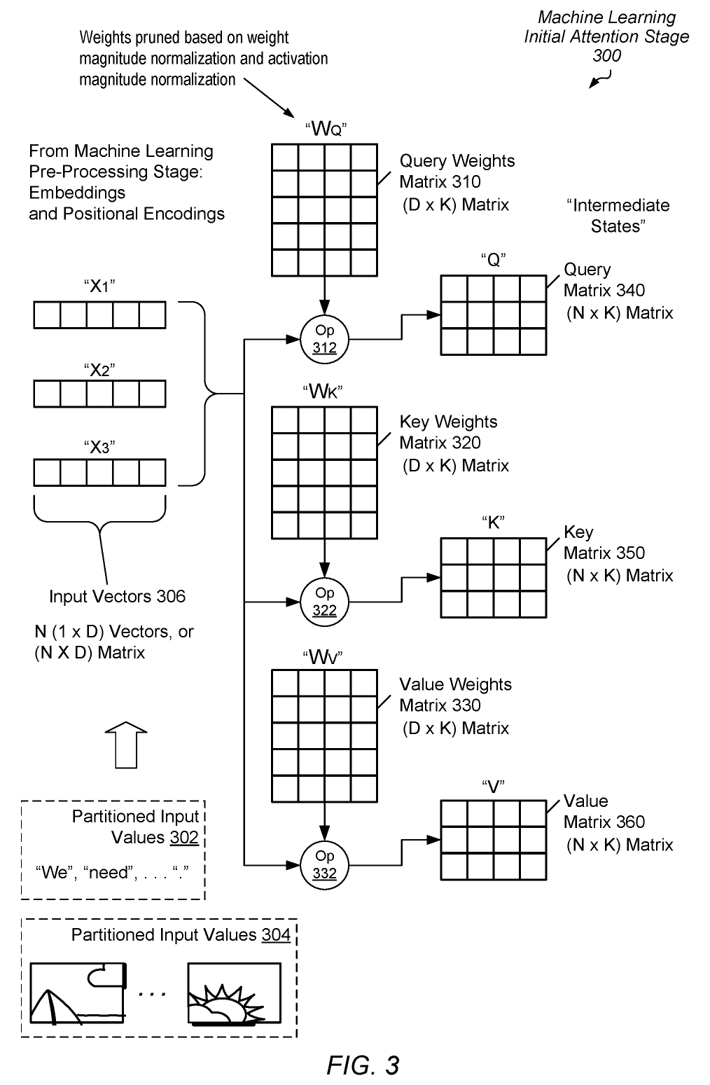

The NLP applications generate content such as answers to questions or paragraphs of an article, provide language translations of sentences and phrases, generate predictions and/or recommendations of search queries, generate classifications of input images, generate images and video frames based on user input, and so forth. Examples of input values 210 are also shown in FIG. 3 as partitioned input values 302, which includes text inputs and punctuation marks of a user query, and partitioned input values 304, which are patches of an input image. Multiple other examples of input values 210 and output values 280 are also possible and contemplated. Examples of LLMs are Generative Pre-trained Transformer 4 (GPT-4) developed by OpenAI, Inc., Large Language Model Meta AI (Llama or LLaMA) developed by Meta AI, Orca developed by Microsoft Corp., Mistral 7B developed by Mistral AI, Stable Diffusion developed by Stability AI, and so forth. Other examples of LLMs are a variety of types of vision transformers (ViT) such as LLMs that utilize Cross-Shaped Window (CSWin) transformer blocks, LLMs that rely on Cross-Attention Multi-Scale Vision Transformer (CrossViT) blocks, LLMs that rely on Data-Efficient Image Transformer (DEIT) blocks, and so forth.

In some implementations, input values 210 are values of a user query that includes a user identifier (ID) and a movie title, a music song title or other item for purchasing or searching that has a corresponding item ID, and the output values 280 include a selection (mouse click) probability on another movie title, song title or other similar item on a web page. In other implementations, input values 210 are input text from a user for a natural language processing (NLP) application. The type of NLP application determines the type of output values 280 generated by transformer stage 260 (and any additional transformer stages 270). The NLP applications can include language translation services, virtual assistants, chatbots, and so forth. In yet other implementations, the input values 210 are patches or subsets of a video frame or an image and the output value 280 is a classification or identifying category of the entire image or multiple classifications of multiple objects in the image. As described earlier, examples of input values 210 are also shown in FIG. 3 as partitioned input values 302, which includes text inputs and punctuation marks of a user query, and partitioned input values 304, which are patches of an input image. Multiple other examples of input values 210 and output values 280 are also possible and contemplated.

Embedding layer 222 of data pre-processing stage 220 converts each input value (or token) of input values 210 to a multi-dimension embedding (embedding vector). In an implementation, the input values 210 includes the sentence “We need coffee.” Each element (word or token or punctuation mark) of the input sequence (sentence that represents input values 210) is converted to a D-dimension embedding vector such as a vector with “D” floating-point numbers where “D” is a positive, non-zero integer. In a simplified implementation, D is 4 and the embedding layer 222 converts the word “coffee” of input values 210 to the 4-dimensional vector (or embedding) equal to [0.674, 0.002, -0.395, 0.983]. Embedding layer 222 performs a similar conversion (mapping) for the other elements (or tokens) “We” and “need” and the punctuation period “.” of the input sequence (input values 210).

In the above example, dimension D is kept small for illustrative purposes. However, in other implementations, another value for dimension D is used based on design requirements. For example, dimension D can be 16, and embedding layer 222 converts the word “coffee” of input values 210 to a 16-dimensional vector (or embedding vector) that includes 16 floating-point numbers. Dimension D can also be 512, and embedding layer 222 converts the word “coffee” of input values 210 to a 512-dimensional vector (or embedding vector) that includes 512 floating-point numbers. In yet other implementations, input values 210 includes three non-overlapping patches or subsets of an image or video frame and embedding layer 222 converts each of the three patches to a D-dimensional vector (or embedding vector). In another example, the image or video frame can be divided into nine respective, non-overlapping and equal-sized patches. When D is 256, the patch that is the top right corner of the image or video frame is converted into an embedding vector with 256 floating-point numbers. Similarly, each of the other eight patches of the total nine patches is converted to a corresponding and unique 256-dimension embedding vector.

Lower dimensional linear embeddings 224 (or embeddings 224) represent the D-dimension vectors (embedding vectors) generated by embedding layer 222. These embeddings 224 are D-dimension numerical representations, which are also referred to as “embedding vectors.” As used herein, each element or individual input value of input values 210 can be referred to as a “token.” In some implementations, each element (or token) of input values 210 is converted into a D-dimension embedding vector by a lookup operation of an embedding table. To generate a D-dimension embedding vector for each of the tokens of input values 210, in some implementations, a variety of mapping techniques can be used to map the embeddings 224 tokens to “latent space vectors” or “latent vectors” or “embedding rows.” Tokenization and mapping cause the original data of input values 210 to be mapped from a higher-dimensional space to a lower-dimensional space while preserving the meaning of the original data. Examples of these other mapping techniques are the Principal Component Analysis (PCA) technique, the Singular Value Decomposition (SVD) technique, the Word2Vec technique, the t-SNE (t-Distributed Stochastic Neighbor Embedding) technique, the UMAP (Uniform Manifold Approximation and Projection) technique, and so forth.

Data pre-processing stage 220 also includes positional encoding 226. Positional encoding layer 226 maps a position of an element of an input sequence, such as input values 210, to a vector of numerical representations. For example, when input values 210 is a sequence of ten textual words or a sequence of ten patches of an image, positional encoding layer 226 provides a unique vector with “D” numerical representations for each of the ten positions within the sequence. Therefore, by using the vectors, positional encoding 226 identifies which textual word or patch is the first element in the sequence of input values 210, identifies which textual word or patch is the second element in the sequence, identifies which textual word or patch is the third element in the sequence, and so on. Positional encoding layer 226 does not use a single numerical value, such as a positional index, for each element of the input sequence since the input sequence can be large and the resulting magnitudes of the indices would be large. The large magnitude would cause the indices to consume a large amount of data storage of the hardware resources of the computing system.

In some implementations, positional encoding layer 226 utilizes one or more of the trigonometric sine function and the trigonometric cosine function to generate the unique numerical representations (positional encoding vectors) to place in the vectors that specify the positional encodings. The frequencies of the selected trigonometric function (sine or cosine) can be set to depend on one or more of the dimension of the embeddings 224, the position of the element in the input sequence (input values 210), the position of the numerical representation within the vector of the element, user-defined values, and so forth. In other implementations, a variety of other functions and method are used to generate the positional encoding vectors. To generate the input vectors 230, positional encoding layer 226 combines the embedding layer 222 with the positional encoding vectors. In an implementation, for each element of the input sequence (input values 210), positional encoding layer 226 sums each numerical representation in the embedding layer 222 with a corresponding numerical representation of the positional encoding vectors. In other implementations, positional encoding layer 226 combines the embedding layer 222 with the positional encoding vectors using a variety of other mathematical computations.

Transformer stage (or model or layer) 260 receives the input vectors 230 from the data pre-processing stage 230. Transformer stage 260 also receives the projection (learnable) weights 232, which are machine learning weights. Transformer stage 260 generates output values, which are used as outputs of machine learning model 200, such as output values 280, or used as inputs to a subsequent transformer stage such as transformer stage 270. Unlike a recurrent neural network (RNN), such as a long short term memory (LSTM) neural network, and other types of neural networks that are sequential machine learning models relying on recurrence and relationships of nearby elements of an input sequence (input values 210), transformer stage 260 provides parallel processing relying on relationships concurrently across all elements of the input sequence. For example, positional encoding layer 226 provided the relationships in the form of positional encoded vectors to be used by transformer stage 260. These positional encoded vectors were combined with the embeddings 224 to generate the input vectors 230.

As described earlier, transformer stages 260 (and 270) utilize self-attention mathematical techniques. These techniques numerically characterize relationships, dependencies and relevance between tokens of the input values 210. These techniques provide context information among the tokens. For example, the token “store” in a sentence or phrase can be a noun such as a physical building or online website where customers shop for items. The token “store” can also be a verb for holding an item in a location for later use. The context and relationships among other tokens provide the actual meaning of the token “store.” To provide the attention mathematical techniques that include relevance and context information, transformer stage 260 utilizes the projection (learnable) weights 232 (or weights 232). A further description of the weights 232 is provided in the description of machine learning initial stage 300 of FIG. 3.

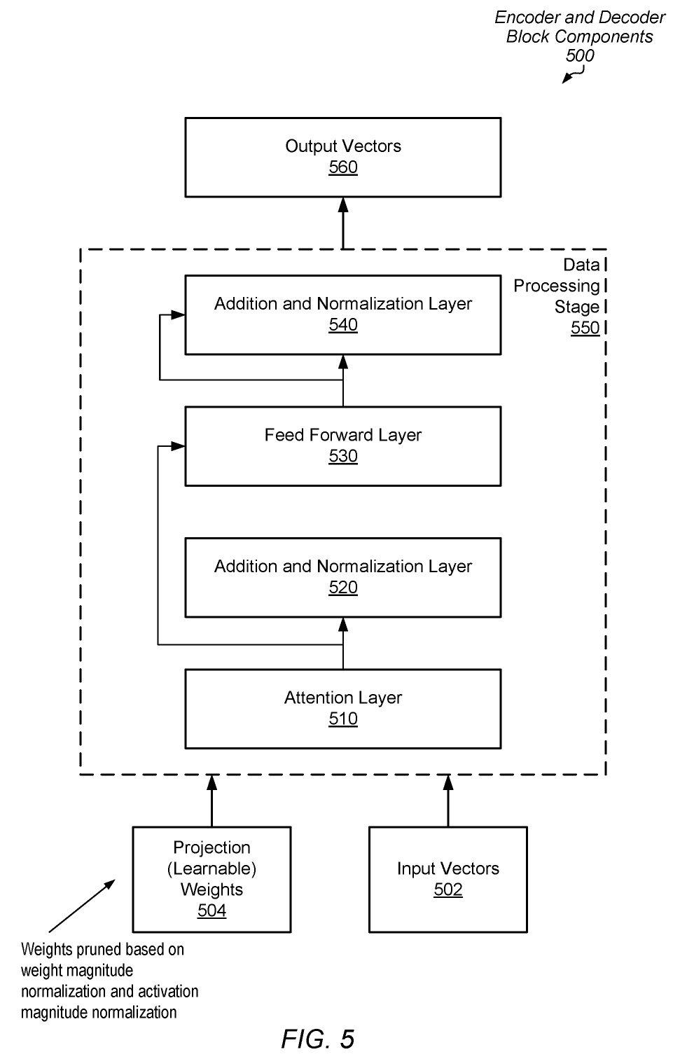

Transformer stage 260 includes one or more encoder blocks, such as encoder block 240 and 242, and one or more decoder blocks, such as decoder block 250 and 252. In various implementations, components of the encoder blocks 240 and 242 and the decoder blocks 250 and 252 are similar. For example, as illustrated in encoder and decoder block components 500 of FIG. 5, encoder and decoder block components can include an attention layer, one or more addition and normalization layers, and a feed forward layer. These layers receive input vectors and generate output vectors. The number and arrangement of the layers is based on a computational graph, such as computational graph 700 of FIG. 7, set up by designers of the machine learning model.

Referring to FIG. 3, a generalized diagram is shown of a machine learning initial attention stage 300 that performs efficient data storage and data transfer of machine learning data. As shown, machine learning initial attention stage 300 (or stage 300) receives input vectors 306 and generates the intermediate states that include the matrices 340, 350 and 360. In various implementations, an embedding layer (not shown), such as embedding layer222 of data pre-processing stage 220 (of FIG. 2), converts each input value (or token) of partitioned input values 302 or 304 to a multi-dimension embedding (embedding vector) such as one of input vectors 306. Partitioned input values 302 includes text inputs and punctuation marks of a user query. Partitioned input values 304 are patches of an input image. Although shown together, stage 300 utilizes one of the partitioned input values 302 and 304 to generate a particular set of the intermediate states that include the matrices 340, 350 and 360. The partitioned input values 302 and 304 are not mixed together.

As shown, partitioned input values 302 includes text words and punctuation marks of a user query such as a sentence, phrase or question. Each element (word or token or punctuation mark) of the user query is converted to a D-dimension embedding vector such as a vector with “D” floating-point numbers where “D” is a positive, non-zero integer. One of the input vectors 306 represents this D-dimension embedding vector in a simplified implementation. For example, the embedding layer converts the token “We” to the D-dimension embedding vector “X₁” of input vectors 306, converts the token “need” to the D-dimension embedding vector “X₂” of input vectors 306, and so forth. In another implementation, embedding layer converts the token that is a patch or subset of a video frame or still image to the D-dimension embedding vector “X₁” of input vectors 306, converts a second patch to the D-dimension embedding vector “X₂” of input vectors 306, and so forth. A positional encoding layer (not shown), such as positional encoding layer 226 of FIG. 2, combines the embedding vectors with corresponding positional encoding vectors to generate the final numerical representations of input vectors 306. Although three input vectors of input vectors 306 are shown, in various implementations, another number of input vectors is used based on design requirements.

The circuitry (not shown) of stage 300 receives the input vectors 306 and receives the projection (learnable) weights 310, 320 and 330, which are machine learning model weights. The circuitry (not shown) of stage 300 generates the intermediate states that include the matrices 340, 350 and 360. As described earlier, transformer stages utilize self-attention mathematical techniques. These techniques numerically characterize relationships, dependencies and relevance between tokens of the input values and tokens of a database to provide probabilities of correct responses or generative content. These techniques provide context information among the tokens. For example, the token “right” in a sentence or phrase can indicate a direction, which is the opposite of “left,” or it can indicate whether a response is correct or incorrect. The context and relationships among other tokens provide the actual meaning of the token “right.” To provide the attention mathematical techniques, stage 300 utilizes the query weights matrix 310, the key weights matrix 320, and the value weights matrix 330.

In various implementations, the circuitry of stage 300 combines the input vectors 306 into a matrix. The circuitry of operator 312 (“Op” 312) performs matrix multiplication using the query weights matrix 310 and the matrix that includes input vectors 306. Each of the input vectors 306 is a (1 x D) vector, and when N vectors are placed together in a matrix, the result is an N x D matrix. The query weights matrix 310 is a (D x K) matrix, and the resulting query matrix 340 is an (N x K) matrix. Here, N, D and K are positive, non-zero integers. Similarly, to generate the key matrix 350, operator 322 performs matrix multiplication using the key weights matrix 320 and the matrix that includes input vectors 306. To generate the values matrix 360, operator 332 performs matrix multiplication using the values weights matrix 330 and the matrix that includes input vectors 306.

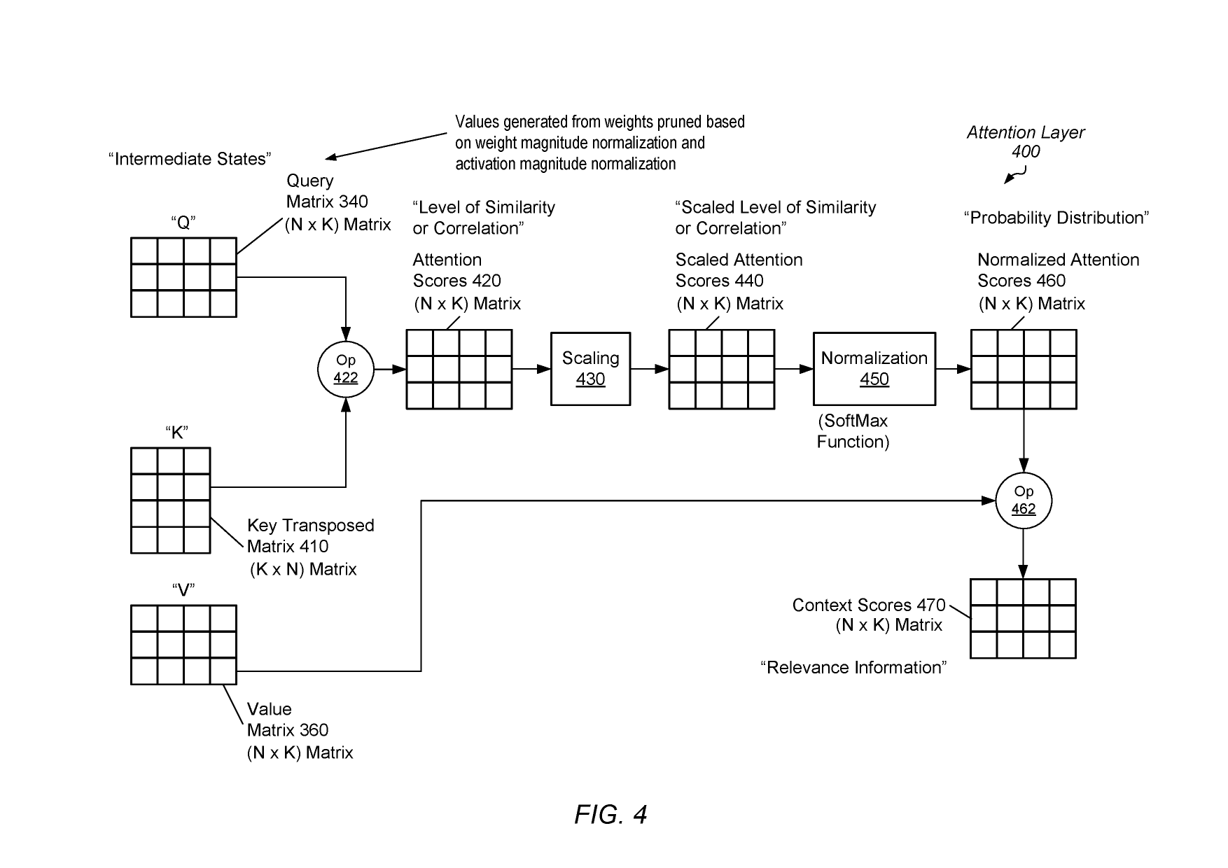

Referring to FIG. 4, a generalized diagram is shown of an attention layer 400 of a machine learning model. Although a particular set of operations and an order of operations is shown, it is understood that in other implementations a variety of other steps and orders can be used to provide context scores 470 to a subsequent stage of data processing to indicate an amount of relevance or similarity among received input values. For example, in other implementations, techniques directed to Flash Attention and Paged Attention can be used. As shown, attention layer 400 receives intermediate states and generates the context scores 470. In various implementations, the intermediate states include the query matrix 340 and value matrix 360 (of FIG. 3) and the key transposed matrix 410, which is a transpose of the key matrix 350 (of FIG. 3). The circuitry of the operator 422 performs a dot product of matrices 340 and 410 to generate the attention scores 420. With the query matrix 340 being an (N x K) matrix and the matrix 410 being a (K x N) matrix, the attention scores 420 is an (N x K) matrix. The attention scores 420 provides a numerical representation of the similarities between the query matrix 340 and the key transposed matrix 410. The scaling block 430 multiplies each matrix element of the attention scores 420 by a scaling factor to generate the scaled attention scores 440, which includes an (N x K) matrix. Scaling block 430 performs scaling to stabilize the attention layer 400. The multiplication of the matrix elements can lead to very large data values, so the matrix elements are reduced by a scaling factor. In some implementations, the scaling factor is the inverse of the square root of dimension D. Therefore, each of the matrix elements of the matrix of the attention scores 420 is divided by the square root of dimension D.

To generate the normalized attention scores 460, the normalization block 450 performs a normalization operation on the scaled attention scores 440. The resulting (N x K) matrix of the normalized attention scores 460 includes each matrix element with a floating-point value between 0 and 1. In various implementations, each row of the resulting (N x K) matrix of the normalized attention scores 460 sums to 1. In some implementations, the normalization operation provides a higher emphasis on higher scaled attention scores and provides a lower emphasis on lower scaled attention scores. Normalization block 450 determines which tokens of an input sequence (input values) should receive more attention for a particular input token. Normalization block 450 generates numerical representations of the relevance of tokens between themselves. When using the normalization block 450, larger scaled attention scores of the scaled attention scores 440 correspond to larger probabilities in the input components will correspond to larger probabilities in the normalized attention scores 460.

In various implementations, normalization block 450 uses the SoftMax function (or softmax function) to perform the normalization operation. For a particular matrix element of a first row of the scaled attention scores 440, the SoftMax function (or softargmax function or normalized exponential function) uses the exponential operation on the matrix element and normalizes the resulting value by dividing the resulting value by the sum of the resulting values of the entire vector. For example, if a vector (row of a matrix) includes the values [0.24, -3.7, 4.3], then the exponentials of each of the elements is [1.27, 0.0247, 73.70]. The sum is (1.27 + 0.0247 + 73.70) or 74.99. The SoftMax function result for the first element of the vector is (1.27 / 74.99) or 0.0169. The SoftMax function result for the vector is [0.0169, 0.000329, 0.983]. These operations are performed for each row (vector) of the scaled attention scores 440 to generate the matrix of the normalized attention scores 560. Afterward, the operator 462 performs matrix multiplication using the matrix of the normalized attention scores 460 and the value matrix 960. The result is the matrix of the context scores 470.

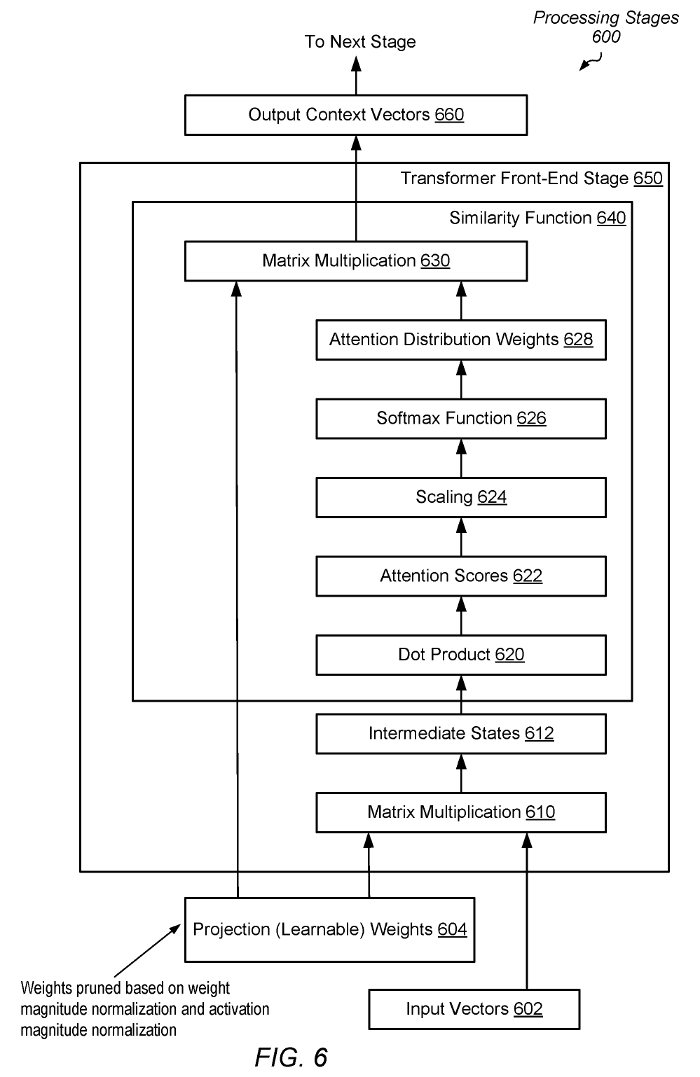

Turning now to FIG. 5, a generalized diagram is shown of encoder and decoder block components 500 of a machine learning model. As shown, encoder and decoder block components 500 (or components 500) receive input vectors 502 and generate output vectors 560 using the data processing stage 550 (or stage 550). In some implementations, stage 550 includes an attention layer 510, one or more addition and normalization layers, such as layers 510 and 540, and a feed forward layer 530. Attention layer 510 generates numerical representations of the relevance of tokens between themselves. Further steps to do this operation are provided in the description of the machine learning initial stage 300 (of FIG. 3), the attention layer 400 (of FIG. 4) and the similarity function 640 (of FIG. 6). The addition and normalization layers 520 and 540 combine values of vectors (rows of matrices) by summing them in some implementations and normalizing them, if necessary. The summation provides a residual connection. Normalization allows output values to not become too large, which allows more layers to be used in the machine learning model.

Feed forward layer 530 typically includes a rectified linear unit (ReLU) layer between two linear layers. The feed forward layer 530 utilizes a multilayer perceptron (MLP) to implement its steps that include feed-forward data movement in hidden layers with no loops. In various implementations, each of the linear layers includes its own set of weights (query weight matrix, key weight matrix, value weight matrix) and performs the steps described for machine learning initial attention stage 300 (of FIG. 3). Therefore, the number of weights can increase considerably, especially when the number of layers increase and the number of encoder blocks and decoder blocks increase. As described earlier, the transformer stage 260 (of FIG. 2) can have any number of encoder blocks 240 and 242 and any number of decoder blocks 250 and 252. In an implementation, there are 6 of each of the encoder blocks and decoder blocks. The inputs to the decoder blocks can originate from the outputs of one or more encoder blocks and one or more decoder blocks. Therefore, the attention techniques are repeated and are based on different layers of the transformer model (or stage or layer). The order of operations and the inputs used for different layers and sub-layers are described in a computational graph such as computational graph 700 (of FIG. 7).

Turning now to FIG. 6, a generalized diagram is shown of processing stages 600 of a transformer of a machine learning model. Similar to ML model 200 (of FIG. 2), stage 300 (of FIG. 3), attention layer 400 (of FIG. 4), and components 500 (of FIG. 5), although a particular set of operations and blocks are shown and an order of operations is shown, it is understood that in other implementations a variety of other steps and orders can be used to provide output values to a subsequent stage of data processing. As shown, processing stages 600 includes transformer front-end stage 650 that receives input vectors 602 and the projection (learnable) weights 604 (or weights 604) and generates output context vectors 660. The transformer front-end stage 650 (or stage 650) includes the similarity function 640, which receives the intermediate states 612 and weighs 604 and generates the output context vectors 660. In various implementations, the input vectors 602 have the format and functionality of input vectors 230 (of FIG. 2), input vectors 306 (of FIG. 3) and input vectors 502 (of FIG. 5). The weights 604 have the format and functionality of weights 962 (of FIG. 2), weight matrices 310, 320 and 330 (of FIG. 3) and weights 504 (of FIG. 5).

During a training phase of the large language model (LLM), multiple initial values of weights and thresholds are input into the LLM, which is executed with multiple iterations until results are determined to be correct above a threshold number of times. Examples of these LLMs include the examples of LLMs described earlier for ML model 200 (of FIG. 2). The training process is an iterative process that generates a set of weight values used for mapping the input data received to the output results. The weights can be optimized for a particular system architecture of a computing device. In some implementations, the training process utilizes unsupervised learning where input data values are provided with no label (expected result). In other implementations, at least a portion of the training process is supervised and includes labels.

In various implementations, stage 650 includes circuitry that performs the operations illustrated in stage 300 (of FIG. 3) and attention layer 400 (of FIG. 4). Matrix multiplication block 610 performs matrix multiplication of input vectors 602 arranged as a matrix and particular matrices of weights 604. In some implementations, matrix multiplication block 610 performs the steps shown in stage 300 (of FIG. 3) to generate the intermediate states 612, which have the format and functionality of the intermediate states shown in stage 300 (of FIG. 3) and attention layer 400 (of FIG. 4). To generate the attention scores 622, the dot product block 620 performs the dot product operation on the key matrix of the intermediate states 612 and the transpose of the key matrix of the intermediate states 612. This is a similar operation performed by operator 422 to generate attention scores 420 (of FIG. 4). Scaling block 624 performs scaling to stabilize the similarity function 640. The multiplication of the matrix elements can lead to very large data values, so the matrix elements are reduced by a scaling factor. In some implementations, the scaling factor is the inverse of the square root of dimension D.

To generate the attention distribution weights 628, the SoftMax function block 626 performs the SoftMax function on the matrix elements of the scaled attention scores from the scaling block 624. This is a similar operation performed by normalization block 550 (of FIG. 4). The matrix multiplication block 630 performs matrix multiplication of the matrix of the attention distribution weights 628 and the values matrix of weights 604. This is a similar operation performed by operator 462 (of FIG. 4). The resulting output context vectors 660 are sent as an output to a next stage of a large langue model (LLM) or as the final results of the LLM.

Turning now to FIG. 7, a generalized diagram is shown of a computational graph 700 of a machine learning model. As shown, computational graph 700 includes multiple stages 710-750 that receives the input values 702 and generates the output values 752. The input values 702 have the format and functionality of input values 210 (of FIG. 2) and the output values 752 have the format and functionality of output values 280 (of FIG. 2). Each of the stages 710-750 includes one or more of the blocks and layers 760 and the nodes 780. The computational graph 700 is a graph that visually represents the computational order of operations to perform to implement a machine learning model, the types of operations to perform, and the data dependencies between the operations to perform. In an implementation, the hierarchy of the computational graph 700 has the stages at the highest level followed by blocks and layers and has the nodes at the lowest level. In other implementations, the terms “stage,” “block,” “layer,” and “node” are used differently to represent a different hierarchy. In computational graph 700, the solid arrows represent edges that indicate the data dependencies. The dashed arrows represent possible data dependencies, which are included in one representation of computational graph 700 but not in another implementation.

Although a particular number and type of stages, blocks, layers and nodes are shown, in other implementations, other types of these components and another number of these components are used, and different available versions of the components are possible and contemplated. The stages 710-750 include one or more of the components of the blocks and layers 760 and the nodes 780. In an implementation, some of the states 710-750 include the same functionality and subsets of multiple stages of stages 710-750 include the same functionality. However, different input values and different weights are processed. For example, the stages 710-750 receive corresponding weights of the machine learning weights 760 (or weights 760). The weights 760 are set during a training process.

In some implementations, the blocks and layers 770 include the encoder block 772, the decoder block 774, the feed forward layer 776 and the similarity function 778. In an implementation, these blocks have the same functionality described earlier for similar components of machine learning model 200 (of FIG. 2), the components 500 (of FIG. 5), and processing stages 600 (of FIG. 6). In an implementation, the nodes 780 include the matrix multiplication node 782, the addition and normalization node 784, the SoftMax function node 786, the rectified linear unit (ReLU) node 788, and the linear node 790. Other examples of a non-linear node besides ReLU node 788 can include one of a variety of types of non-linear functions such as a Gaussian error linear unit (GELU) function, a Sigmoid function, a Swish gated linear unit (SwigLU) function, and so forth. Designers construct computational graph 700 to provide the functionality of the desired machine learning model such as at least machine learning model 200 (of FIG. 2).

In various implementations, the ML model is written by a developer in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Matplotlib, Pandas and so on. A predefined module can be called similar to a function call and the predefined module includes a directed acyclic graph (DAG) providing a sequence of execution steps of a non-recurring computation. The layers 770 and nodes 780 provide the predefined modules to use in stages 710-750. The execution nodes of the DAG represent the predefined modules providing the mathematical expressions or operations to perform. Similar to the solid and dashed lines between stages 710-750, within each of the stages 710-750, there are lines representing the data flow between the predefined modules. These lines are also referred to as edges, and the edges of the DAG between the execution nodes represent data dependencies. The imported ML libraries and predefined modules are used to create computational graph 700.

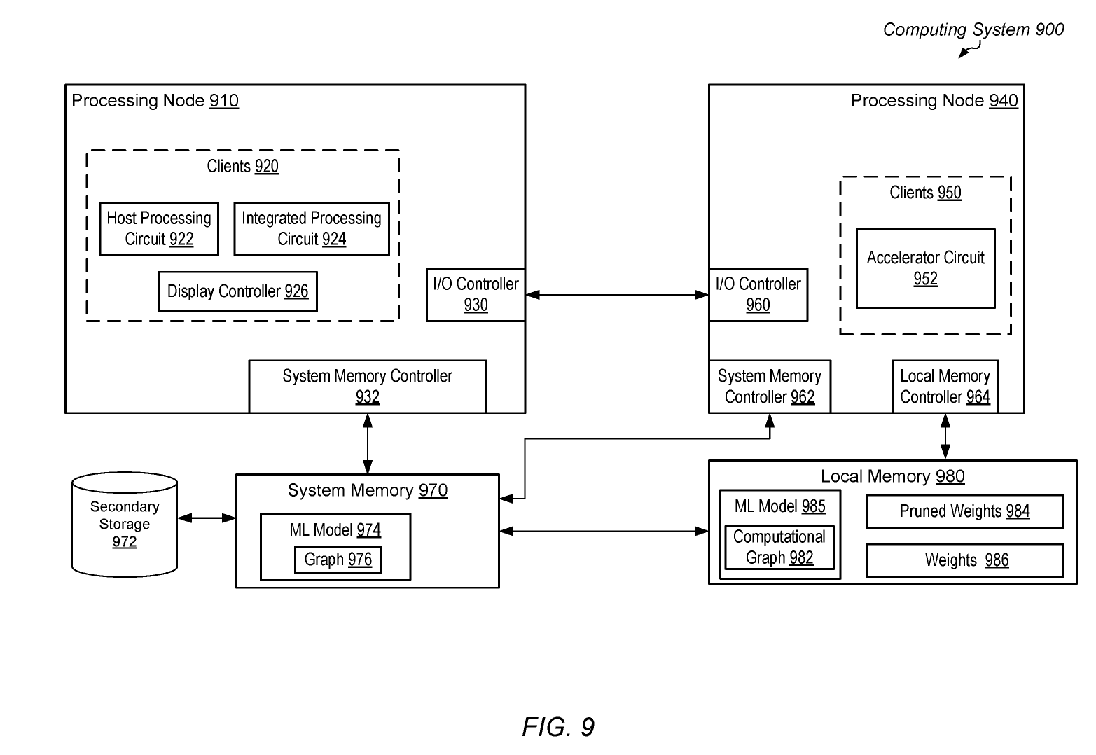

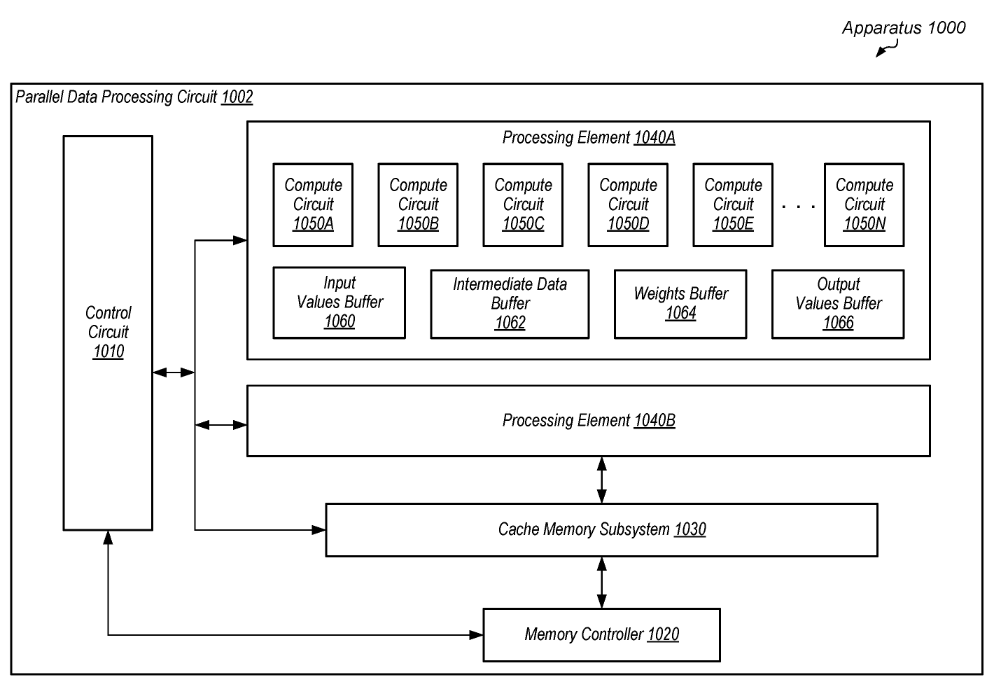

For the methods 800 and 1100, a computing system includes multiple processing circuits. Examples of the host processing circuit of the multiple processing circuits is host processing circuit 922 (of FIG. 9). Examples of the accelerator circuit of the multiple processing circuits are accelerator circuit 952 (of FIG. 9) and parallel data processing circuit 1002 (of FIG. 10). For the methods 800 and 1100, the multiple processing circuits execute a variety of types of parallel data applications such as a variety of types of machine learning (ML) models.

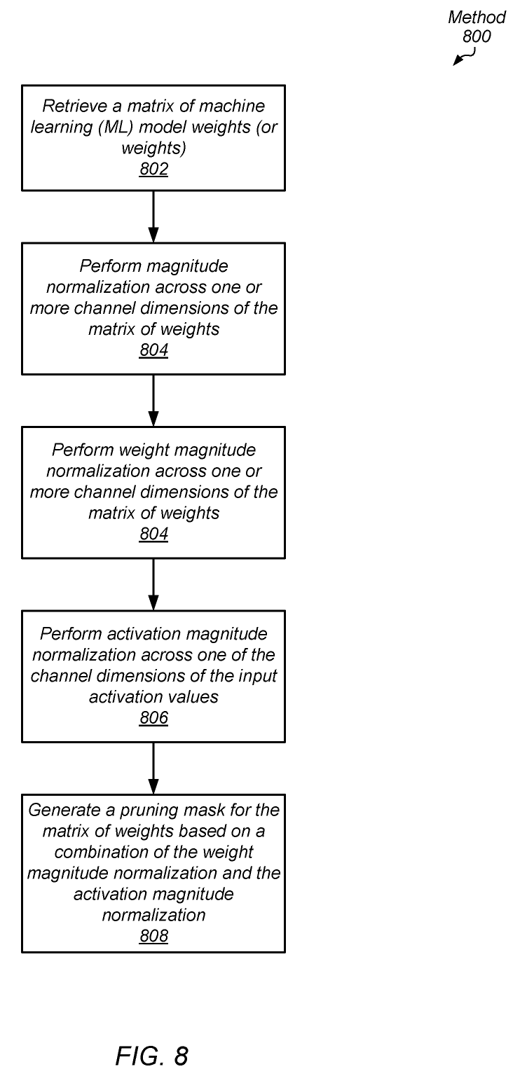

Referring to FIG. 8, a generalized diagram is shown of a method 800 for performing efficient data storage and data transfer of machine learning data. For purposes of discussion, the steps in this implementation are shown in sequential order. However, in other implementations some steps occur in a different order than shown, some steps are performed concurrently, some steps are combined with other steps, and some steps are absent.

In various implementations, machine learning model weights (or weights) have set values based on training of a corresponding machine learning model such as a large language model (LLM). Examples of these LLMs include the examples of LLMs described earlier for ML model 200 (of FIG. 2). During the training phase of the LLM, multiple initial values of weights and thresholds are input into the LLM, which is executed with multiple iterations until results are determined to be correct above a threshold number of times. The training process is an iterative process that generates the final values of the weights used during inference for mapping the input data received to output results. One of the multiple processing circuits of the computing system retrieves a matrix of machine learning (ML) model weights (or weights) (block 802).

The processing circuit performs magnitude normalization across one or more channel dimensions of the matrix of weights (block 804). In various implementations, the processing circuit performs weights magnitude normalization such as the steps performed on weights matrix 110 to generate the pruning metrics matrix 140 (of FIG. 1). The processing circuit performs activation magnitude normalization across one of the channel dimensions of the input activation values (block 806). The processing circuit generates a pruning mask for the matrix of weights based on a combination of the weight magnitude normalization and the activation magnitude normalization (block 808).

Turning now to FIG. 9, a generalized diagram is shown of a computing system 900 that performs efficient data storage and data transfer of machine learning data. As shown, computing system 900 includes the processing nodes 910 and 940, system memory 970, secondary storage 972, and local memory 980. The hardware, such as circuitry, of each of the first processing node 910 and the second processing node 940 provides a variety of functionalities. For example, the first processing node 910 includes numerous semiconductor dies such as the clients 920 and the second processing node 940 includes the clients 950. As used herein, a “client” refers to an integrated circuit with data processing circuitry and internal memory, which has tasks assigned to it by a scheduler such as an operating system (OS) scheduler or other. Examples of tasks are software threads of a process of an application, which are scheduled by the OS scheduler.

Examples of clients are a general-purpose central processing unit (CPU), a parallel data processing unit with a relatively wide single-instruction-multiple-data (SIMD) microarchitecture, a multimedia integrated circuit, one of a variety of types of an application specific integrated circuit (ASIC), a digital signal processor (DSP), a field programmable gate array (FPGA), one or more microcontrollers, and so forth. Other examples of the parallel data processing circuit are a graphics processing unit (GPU), an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on. For example, the clients 920 of the processing node 910 include at least the host processing circuit 922, the integrated processing circuit 924, such as an integrated GPU (or iGPU), and the display controller 926. The clients 950 of the processing node 940 includes at least the accelerator circuit 952. Clock sources, such as phase lock loops (PLLs), an interrupt controller, a communication fabric, power controllers, and so forth are not shown in the computing system 900 for ease of illustration. It is also noted that the number of components of the computing system 900 and the number of subcomponents for those shown in FIG. 9, such as within the clients 920 and 950, can vary from implementation to implementation. There can be more or fewer of each component/subcomponent than the number shown for the computing system 900.

In an implementation, the processing node 910 is a system on a chip (SoC) in a semiconductor package on a motherboard and the system memory 970 is one of a variety of types of synchronous random-access memory (SRAM) in a separate semiconductor package on the motherboard. The processing node 910 accesses system memory 970 while processing tasks of a workload. The processing node 910 uses the system memory controller 932 to transfer data with the system memory 970 via a corresponding communication channel that is a point-to-point communication channel. The address information, command information, response data, payload data, header information, and other types of information are transferred on metal traces or wires that are accessible by only the single source and the single destination. In various implementations, processing node 940 uses the system memory controller 962 to transfer data with the system memory 970 via a corresponding communication channel that is also a point-to-point communication channel. In an implementation, the system memory controller 932, the system memory controller 962, and the system memory 970 support one of a variety of types of a Double Data Rate (DDR) communication protocol or one of a variety of types of a Low-Power Double Data Rate (LPDDR) communication protocol.

Secondary storage 972 is a lower level than system memory 970 in the memory hierarchy of computing system 900. Typically, secondary storage 972 is a hard disk drive (HDD) or solid-state drive (SSD) providing non-volatile data storage. The processing node 940 accesses the local memory 980 while processing tasks of a workload. Local memory 980 can be on-chip memory or off-chip memory. In an implementation, the processing node 940 is a system on a chip (SoC) in a semiconductor package on the motherboard and the local memory 980 is one of a variety of types of SRAM located nearby to processing node 940. In another implementation, processing nodes 910 and 940 are located on the same SoC. The processing node 940 uses the local memory controller 964 to transfer data with the local memory 980. In an implementation, the local memory controller 964 supports one of a variety of types of a Graphics Double Data Rate (GDDR) communication protocol.

Between input/output (I/O) controllers 930 and 960, the communication channel transfers data between integrated circuits of the processing nodes 910 and 940. In an implementation, the I/O interfaces 930 and 960 support a communication protocol such as the Peripheral Component Interconnect Express (PCIe) protocol. Similar to other interfaces, such as the system memory controllers 932 and 962 and local memory controller 964, the I/O controllers 930 and 960 include one or more queues for storing requests, responses, and messages, and include circuitry that builds packets for transmission, disassembles packets upon reception, and supports a particular communication protocol.

In various implementations, accelerator circuit 952 executes a variety of types of parallel data applications such as machine learning (ML) models. System memory 970 stores instructions describing one or more algorithms of machine learning (ML) model 974 that analyze data to generate one or more predictions or classifications. In various implementations, to generate predictions or classifications, ML model 974 has the functionality of ML model 200 (of FIG. 2), processing stages 600 (of FIG. 6), and computational graph 700 (of FIG. 7). In some implementations, the ML model 974 is one of a variety of types of a large language model (LLM). Examples of these LLMs include the examples of LLMs described earlier for ML model 200 (of FIG. 2). In various implementations, ML model 974 is written by developers in one of a variety of high-level programming languages such as Python, R, Julia, C, C++, C#, and Java and so on.

Machine learning libraries can be used with these high-level programming languages to provide predefined modules to aid developers when building the ML application (ML model). Examples of the ML libraries are TensorFlow, Pytorch, Numpy, Keras, Matplotlib, Pandas and so on. A predefined module can be called similar to a function call and the predefined module includes a directed acyclic graph (DAG) providing a sequence of execution steps of a non-recurring computation. A predefined module can be called similar to a function call and the predefined module includes a directed acyclic graph (DAG) providing a sequence of execution steps of a non-recurring computation. The imported ML libraries are used to create computational graphs that provide the computational order of the ML nodes, layers and stages of the ML model. The imported ML libraries are used to create computational graphs that provide the computational order of the ML nodes, layers and stages of the ML model.

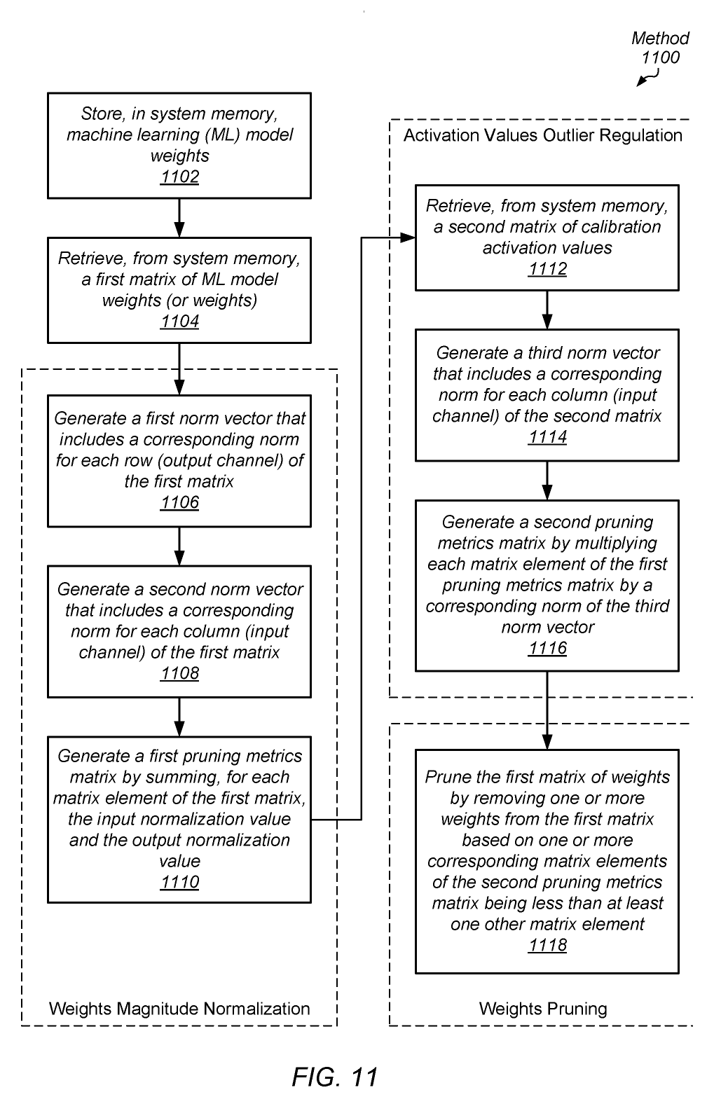

The imported ML libraries are used to create computational graphs that provide the computational order of the ML nodes, layers and stages of the ML model. For example, accelerator circuit 952 executes instructions of nodes, layers and stages of ML model 985 in a computational order of computational graph 982. Computational graph 982 has the form of computational graph 700 (of FIG. 7). ML model 985 stored in local memory 980 includes commands translated from instructions of ML model 974 stored in system memory 970. Computational graph 982 stored in local memory 980 is a copy of computational graph 976 stored in system memory 970. One or more of clients 920 and 950 prune machine learning weights (or weights) of a trained ML model. In an implementation, the pruning is performed using steps described earlier for weights pruning 100 (of FIG. 1), method 800 (of FIG. 8), and method 1100 (of FIG. 11). Local memory 980 stores the pruned weights 984 and non-pruned weights 986. System memory 970 stores a copy of at least the non-pruned weights, although system memory 970 can also store a copy of pruned weights.

Host processing circuit 922 begins processing the instructions of the ML model and a library uses a user mode driver (UMD) to translate function calls in the application to commands particular to a piece of hardware such as accelerator circuit 952. The commands are included in one or more of ML model 985 and computational graph 982 stored in local memory 980. Based on the computational graph 982, accelerator circuit 952 detects a next machine learning (ML) node to execute and retrieves required weights from the pruned weights 984. Accelerator circuit 952 executes the ML node using the retrieved weights. For example, accelerator circuit 952 adds the ML node to a work queue (or machine learning queue or scheduler queue) that includes a pointer to the storage location of the local memory 980 that stores the required weights of pruned weights 984. In various implementations, local memory 980 also stores calibration activation values (not shown). As described earlier, the intermediate data includes activation vectors, key vectors and value vectors. For example, the intermediate data can include vectors (rows) of one or more of the query matrix 340, the key matrix 350, the values matrix 360 of FIG. 3, attention scores matrix 420 and context scores matrix 470 of FIG. 4, other outputs of layers 510-540 of encoder and decoder block components 500 of FIG. 5, and one or more outputs of sub-layers and layers of processing stages 600 of FIG. 6.

Turning now to FIG. 10, a block diagram is shown of an apparatus 1000 that performs efficient data storage and data transfer of machine learning data. In one implementation, apparatus 1000 includes parallel data processing circuit 1002. As shown, parallel data processing circuit 1002 includes control circuit 1010, memory controller 1020, cache memory subsystem 1030 and processing elements 1040A-1040B. Examples of parallel data processing circuit 1002 are the same as examples of accelerator circuit 952 (of FIG. 9). In various implementations, parallel data processing circuit 1002 executes a variety of types of parallel data applications such as machine learning (ML) models. For example, parallel data processing circuit 1002 executes instructions of nodes, layers and stages of a ML model in a computational order of a computational graph such as computational graph 700 (of FIG. 7).

Parallel data processing circuit 1002 includes at least control circuit 1010, processing elements 1040A-1040B, cache memory subsystem 1030, and memory controller 1020. Each of processing elements 1040A-1040B includes the multiple compute circuits 1050A-1050N and multiple buffers such as input values buffer 1060, intermediate data buffer 1062, weights buffer 1064 and output values buffer 1066. It should be understood that the components and connections shown for parallel data processing circuit 1002 are merely representative of one type of processing circuit and does not preclude the use of other types of processing circuits for implementing the techniques presented herein. The apparatus 1000 also includes other components which are not shown to avoid obscuring the figure such as at least a communication fabric, one or more system buses, clock signal generating circuitry, power management circuitry, input/output (I/O) interfaces and so on. In other implementations, the parallel data processing circuit 1002 includes other components, omits one or more of the illustrated components, has multiple instances of a component even if only one instance is shown in the apparatus 1000, and/or is organized in other suitable manners. Also, each connection shown in apparatus 1000 is representative of any number of connections between components. Additionally, other connections can exist between components even if these connections are not explicitly shown in apparatus 1000.

Although a single memory controller 1020 is shown, it is possible and contemplated that parallel data processing circuit 1002 includes multiple memory controllers supporting one or more communication protocols with a variety of data storage devices. In an implementation, memory controller 1020 (and any other memory controller) directly communicates with each of the processing elements 1040A-1040B and cache memory subsystem 1030 and includes circuitry for supporting communication protocols and queues for storing requests and responses. As part of executing an application, such as an ML model, a host CPU (not shown) launches kernels to be executed by parallel data processing circuit 1002. Control circuit 1010 receives kernels from the host CPU either directly or via system memory and determines when to dispatch kernels for execution on compute circuits 1050A-1050N of processing elements 1040A-1040B.

Parallel threads executing on compute circuits 1050A-1050N read data from and write data to the cache memory subsystem 1030, vector general-purpose registers, scalar general-purpose registers, and one or more of buffers 1060-1066. In various implementations, the circuitry of processing element 1040B is a replicated instantiation (or silicon integrated circuit copy) of the circuitry of processing element 1040A. In some implementations, each of the processing elements 1040A-1040B is a chiplet. As used herein, a “chiplet” is a semiconductor die (or die) fabricated separately from other dies, and then interconnected with these other dies in a single integrated circuit in the multi-chip module (MCM). On a single silicon wafer, multiple chiplets can be fabricated as multiple instances of particular integrated circuitry. A first silicon wafer (or first wafer) is fabricated with multiple instances of integrated circuitry of a first chiplet, and this first wafer is diced using laser cutting techniques to separate the multiple copies of the first chiplet. A second silicon wafer (or second wafer) is fabricated with multiple instances of integrated circuitry of a second chiplet, and this second wafer is diced using laser cutting techniques to separate the multiple copies of the second chiplet.

In an implementation, each of the multiple compute circuits 1050A-1050N includes one or more vector processing circuits with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the multiple vector processing circuits, compute circuits 1050A-1050N also include an assigned number of vector general-purpose registers (VGPRs), an assigned number of scalar general-purpose registers (SGPRs), and an assigned data storage space of one or more of buffers 1060-1066. Schedulers in one or more of control circuit 110, processing elements 1040A-1040B and compute circuits 1050A-1050N receive instructions, such as instructions of stages, layers and nodes of a ML model, and determine when to execute the instructions.

As described earlier, for the methods 800 and 1100, a computing system includes multiple processing circuits. Examples of the host processing circuit of the multiple processing circuits is host processing circuit 922 (of FIG. 9). Examples of the accelerator circuit of the multiple processing circuits are accelerator circuit 952 (of FIG. 9) and parallel data processing circuit 1002 (of FIG. 10). For the methods 800 and 1100, the multiple processing circuits execute a variety of types of parallel data applications such as a variety of types of machine learning (ML) models.

Referring to FIG. 11, a generalized diagram is shown of a method 1100 for performing efficient data storage and data transfer of machine learning data. For purposes of discussion, the steps in this implementation are shown in sequential order. However, in other implementations some steps occur in a different order than shown, some steps are performed concurrently, some steps are combined with other steps, and some steps are absent.

System memory stores machine learning (ML) model weights (block 1102). A processing circuit retrieves, from system memory, a first matrix of ML model weights (or weights) (block 1104). The processing circuit generates a first norm vector that includes a corresponding norm for each row (output channel) of the first matrix (block 1106). The processing circuit generates a second norm vector that includes a corresponding norm for each column (input channel) of the first matrix (block 1108). The processing circuit generates a first pruning metrics matrix by summing, for each matrix element of the first matrix, the input normalization value and the output normalization value (block 1110). The processing circuit retrieves, from system memory, a second matrix of calibration activation values (block 1112).

The processing circuit generates a third norm vector that includes a corresponding norm for each column (input channel) of the second matrix (block 1114). The processing circuit generates a second pruning metrics matrix by multiplying each matrix element of the first pruning metrics matrix by a corresponding norm of the third norm vector (block 1116). The processing circuit prunes the first matrix of weights by removing one or more weights from the first matrix based on one or more corresponding matrix elements of the second pruning metrics matrix being less than at least one other matrix element (block 1118).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a control circuit configured to:
generate a first norm vector comprising a corresponding norm for each row of a first matrix of a plurality of matrices of machine learning model weights;
generate a second matrix comprising a corresponding pruning metric for each machine learning model weight of the first matrix, based at least in part on the first norm vector; and
prune the machine learning model weights of the first matrix to generate a pruned first matrix by removing one or more machine learning model weights from the first matrix, responsive to one or more corresponding pruning metrics being less than at least one other pruning metric of the second matrix; and
one or more compute circuits configured to:
execute a machine learning model using machine learning model weights of the pruned first matrix.

2. The apparatus as recited in claim 1, wherein the control circuit is configured to:
generate a second norm vector comprising a corresponding norm for each column of the first matrix; and
generate the second matrix by generating the corresponding pruning metric for each machine learning model weight of the first matrix based further in part on the second norm vector.

3. The apparatus as recited in claim 2, wherein the control circuit is configured to generate the second matrix by summing, for each pruning metric:
a first ratio of a corresponding machine learning model weight from the first matrix to a norm of the first norm vector corresponding to a row of the corresponding machine learning model weight; and
a second ratio of the corresponding machine learning model weight from the first matrix to a norm of the second norm vector corresponding to a column of the corresponding machine learning model weight.

4. The apparatus as recited in claim 3, wherein the control circuit is configured to generate a third norm vector comprising a corresponding norm for each row or for each column of a third matrix comprising input activation values.

5. The apparatus as recited in claim 4, wherein the control circuit is configured to:
generate a fourth norm vector by generating a square root of each norm of the third norm vector; and
generate the second matrix by generating, for each pruning metric, a product of the pruning metric and a norm of the fourth norm vector corresponding to a column or a row of the pruning metric.

6. The apparatus as recited in claim 1, wherein the one or more compute circuits are configured to:
generate an output value by executing at least one or more attention layers of the machine learning model using the pruned first matrix and input activation values, wherein the output value represents a prediction based on one or more input data values received from a host processing circuit; and
send the output value to the host processing circuit.

7. The apparatus as recited in claim 1, wherein using the pruned first matrix and input activation values retrieved from buffers of the apparatus, the one or more compute circuits execute a plurality of layers of the machine learning model that is a large language model in a computation order specified by a computational graph generated by a host processing circuit.

8. A method, comprising:
generating, by control circuitry, a first norm vector comprising a corresponding norm for each row of a first matrix of a plurality of matrices of machine learning model weights;
generating, by control circuitry, a second matrix comprising a corresponding pruning metric for each machine learning model weight of the first matrix, based at least in part on the first norm vector; and
pruning, by the control circuitry, the machine learning model weights of the first matrix by removing one or more machine learning model weights from the first matrix, responsive to one or more corresponding pruning metrics being less than at least one other pruning metric of the second matrix.

9. The method as recited in claim 8, further comprising:
generating a second norm vector comprising a corresponding norm for each column of the first matrix; and
generating the second matrix by generating the corresponding pruning metric for each machine learning model weight of the first matrix based further in part on the second norm vector.

10. The method as recited in claim 9, further comprising generating the second matrix by summing, for each pruning metric:
a first ratio of a corresponding machine learning model weight from the first matrix to a norm of the first norm vector corresponding to a row of the corresponding machine learning model weight; and
a second ratio of the corresponding machine learning model weight from the first matrix to a norm of the second norm vector corresponding to a column of the corresponding machine learning model weight.

11. The method as recited in claim 10, further comprising generating a third norm vector comprising a corresponding norm for each row or for each column of a third matrix comprising input activation values.

12. The method as recited in claim 11, further comprising generating a fourth norm vector by generating a square root of each norm of the third norm vector.

13. The method as recited in claim 12, further comprising generating the second matrix by generating, for each pruning metric, a product of the pruning metric and a norm of the fourth norm vector corresponding to a column or a row of the pruning metric.

14. The method as recited in claim 8, wherein each row of the first matrix corresponds to an output channel of the machine learning model.

15. A computing system comprising:
a system memory comprising circuitry configured to store a plurality of machine learning model weights arranged as a plurality of matrices; and
a processing circuit configured to execute a plurality of layers of a machine learning model in a computation order specified by a computational graph;
wherein the processing circuit comprises:
a plurality of compute circuits; and
a control circuit configured to:
retrieve, from the system memory, a first matrix of the plurality of matrices;
generate a first norm vector comprising a corresponding norm for each row of the first matrix;
reduce influence of outliers of the plurality of machine learning model weights on intermediate data of the machine learning model comprising a second matrix by generating a corresponding pruning metric for each machine learning model weight of the first matrix based at least in part on the first norm vector; and
prune the plurality of machine learning model weights by removing one or more machine learning model weights from the first matrix, responsive to one or more corresponding pruning metrics being less than at least one other pruning metric of the second matrix.

16. The computing system as recited in claim 15, wherein the control circuit is configured to:
generate a second norm vector comprising a corresponding norm for each column of the first matrix; and
generate the second matrix by generating the corresponding pruning metric for each machine learning model weight of the first matrix based further in part on the second norm vector.

17. The computing system as recited in claim 16, wherein the control circuit is configured to generate the second matrix by summing, for each pruning metric:
a first ratio of a corresponding machine learning model weight from the first matrix to a norm of the first norm vector corresponding to a row of the corresponding machine learning model weight; and
a second ratio of the corresponding machine learning model weight from the first matrix to a norm of the second norm vector corresponding to a column of the corresponding machine learning model weight.

18. The computing system as recited in claim 17, wherein the control circuit is configured to generate a third norm vector comprising a corresponding norm for each row or for each column of a third matrix comprising input activation values.

19. The computing system as recited in claim 18, wherein the control circuit is configured to generate a fourth norm vector by generating a square root of each norm of the third norm vector.

20. The computing system as recited in claim 19, wherein the control circuit is configured to generate the second matrix by generating, for each pruning metric, a product of the pruning metric and a norm of the fourth norm vector corresponding to a column or a row of the pruning metric.
